(19) United States
(12) Patent Application Publication
(10) Pub. No.: US 2023/0062954 A1
(43) Pub. Date: Mar. 2, 2023

(54) Strap Device for Hands-Free Garden Hose Nozzle

(71) Applicant: Mary Ellison, Lapeer, MI (US)

(72) Inventor: Mary Ellison, Lapeer, MI (US)

(21) Appl. No.: 17/705,644

(22) Filed: Mar. 28, 2022

Related U.S. Application Data
(60) Provisional application No. 63/240,097, filed on Sep. 2, 2021.

(51) Int. Cl. B05B 15/63; B05B 1/12; B05B 1/02; B05B 15/62

(52) U.S. Cl. CPC B05B 15/63; B05B 1/02; B05B 1/12; B05B 15/62

(57) ABSTRACT

The present invention relates to a strap system for hanging a garden hose nozzle from an elevated position . The strap system is configured to be mounted on the nozzle without affecting the nozzle operation. More specifically, the strap system has a vertical hanging strap with a closed loop, a front barrel strap, and a handle strap. The front barrel strap secures around the front shower head of the nozzle and the handle strap secures around grip of the nozzle. The vertical hanging strap may be slid onto a hook or other surface to support the nozzle in a hands-free elevated position allowing people to use the hanging nozzle as a standing shower or other elevated watering application.

### CROSS-REFERENCE TO RELATED APPLICATION

The present application claims priority to, and the benefit of, U.S. Provisional Application No. 63/240,097, which was filed on Sept. 2nd, 2021, and is incorporated herein by reference in its entirety.

### FIELD OF THE INVENTION

The present invention relates generally to the field of lawn care accessories. More specifically, the present invention relates to a strap system or support accessory for utilizing an existing garden hose and nozzle as a means for outdoor, stationary, and hands-free showering. The strap system features several straps that work in conjunction to slide over the garden hose and then over a sturdy tree branch, post, or garden hook to support the nozzle and hose at a convenient height to allow an individual to shower or bathe beneath the water outlet of the hose and/or nozzle. The strap system may be constructed from a rigid material or may be elastic such as a rubber or silicone material. Accordingly, the present disclosure makes specific reference thereto. Nonetheless, it is to be appreciated that aspects of the present invention are also equally applicable to other like applications, devices and methods of manufacture.

### BACKGROUND

By way of background, a garden hose and nozzle is a multipurpose device used by people to maintain and clean large outdoor living spaces, automobiles, pets and other applications which require the use of water, such as for watering gardens, flowers and trees. Garden hose and nozzle combinations enable people to accomplish a number of tasks ranging from misting flower beds, to washing a car in a less labor-intensive way. The nozzle device includes a trigger that is used for spraying and dispersing water in a number of patterns as well as to expel water further distances than would otherwise be capable with just a hose by itself.

The most common use of a garden hose nozzle is as a garden watering accessory capable of watering lawns, trees, flowers or a garden. However, commercially available garden hose nozzles and other outdoor shower nozzles are inefficient and lack convenience for other uses than those which are customary. People are required to continuously hold the hose or the nozzle during use which can be extremely frustrating, particularly when the user needs to use their hands for other activities. Further, people need to continuously apply pressure to the trigger of the nozzle which can hurt hands after some time. People desire a system that can allow them to use the conventional garden hose nozzles as a hands-free nozzle and shower system.

Some garden hose nozzles come with a spike that is inserted into the ground to support the hose and nozzle combination. The spike allows the hose to be used in a ground-based fashion however this application limits the use and reach of the nozzle and people may desire to use the garden hose nozzle at an elevated position so that they can reach taller items and even stand under the hose and water stream.

Rinsing both hands at the same time while using the garden hose nozzle is not possible for an individual alone and requires at least two individuals where one person holds the hose and the other person rinses their hands. When a person is alone, the person needs to go to a tap to rinse hands which is time consuming and inconvenient for an individual. People desire a way to individually use standard hose nozzles for rinsing hands.

Therefore, there exists a long-felt need in the art for a system that allows people to utilize the garden hose and nozzle combination as an outdoor, hands-free shower. There is also a long-felt need in the art for an invention that elevates a garden hose nozzle in a vertical direction and to a height that may allow use by individuals. Additionally, there is a long-felt need in the art for a garden hose and nozzle combination supporting device that eliminates the need for people to continuously hold the hose or nozzle during use of the garden hose nozzle. Moreover, there is a long-felt need in the art for a garden hose nozzle supporting device that does not reduce the water flow of the nozzle and can also be used to control the water flow level. Further, there is a long-felt need in the art for a garden hose and nozzle combination supporting invention that allows an individual to use the nozzle for easily rinsing hands. Finally, there is a long-felt need in the art for a device that supports the hose nozzle in a hands-free elevated position for rinsing off hands, tools, taking a shower and other activities.

The subject matter disclosed and claimed herein, in one embodiment thereof, comprises a rubber garden hose and nozzle strap combination. The garden hose nozzle strap is designed to support a garden hose nozzle for providing a functional, efficient, and hands-free use such as an outdoor shower system. The garden hose and nozzle combination strap includes a one-piece integral structure, the structure has a vertical hanging strap with a closed loop, a front barrel strap and a handle strap. The handle strap is configured to encircle a portion of the grip of the nozzle and the front barrel strap is positioned around the front shower head of the nozzle such that the vertical hanging strap is used for sliding onto a sturdy tree branch, post, wall, or garden hook to support the hose in a hands-free elevated position.

In this manner, the strap system of the present invention for garden hose and nozzle combinations accomplishes all of the forgoing objectives and provides a relatively easy and convenient solution to utilize an existing garden hose as an outdoor, stationary, and hands-free showering, washing or cleaning accessory. The strap allows individuals to utilize the elevated hose and/or nozzle as an outdoor hands-free shower, watering and cleaning tool for a variety of purposes. The strap can be used with a tree branch, posts, walls, or garden hook to support the hose and/or nozzle in a hands-free elevated position eliminating the need for a user to continuously hold the hose.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a garden hose and nozzle combination strap. The rubber garden hose and nozzle combination strap includes a one-piece integral structure. The structure has a vertical hanging strap with a closed loop, a front barrel strap and a handle strap. The handle strap is configured to encircle a portion of the grip of the nozzle and the front barrel strap is positioned around the front of the shower head of the nozzle such that the vertical hanging strap is used for sliding onto a sturdy tree branch, post, wall, or garden hook to support the hose in a hands-free elevated position.

In yet another embodiment, the garden hose nozzle strap is made from synthetic rubber, silicone or other elastic material. In an alternative embodiment, the strap may be constructed from polyethylene, polystyrene, recycled plastics and other semi-rigid materials.

In yet another embodiment, the garden hose nozzle strap does not obstruct the sprinkle or spray of the water flow being emitted from the nozzle.

In yet another embodiment, the front barrel strap and the handle strap are adjustable for accommodating nozzles of various sizes, types and designs.

In yet another embodiment, a method for hanging a garden hose nozzle from a garden hook, post, wall, or a tree branch is described. The method allows individuals to use the garden hose nozzle in a hands-free operation. More specifically, the method includes the steps of providing a garden hose nozzle strap. The strap is configured to mount on the nozzle and includes a handle strap, a front barrel strap and a vertical hanging strap. Next, the vertical hanging strap is slid or positioned onto the garden hook, post, wall, or the tree branch for hanging the nozzle. Finally, rotating the tab feature down to keep the water flow turned on and adjusting the spray to the desired spray pattern.

In yet another embodiment, the hanging nozzle is used for rinsing off hands, tools, sprinkling water and other tasks that an individual may require.

In yet another embodiment, a strap system for utilizing an existing garden hose nozzle as an outdoor, stationary, and hands-free showering or watering tool is disclosed. The strap system is one-piece integral device that includes a vertical hanging strap with a closed loop, a front barrel strap, and a handle strap. The front barrel strap wraps around the front barrel head of the nozzle, the handle strap wraps around the grip of the nozzle and the vertical hanging strap is configured to slide onto a sturdy tree branch, post, wall, or garden hook to support the hose and nozzle in a hands-free elevated position.

In yet another embodiment, an on/off sprayer tab may be located on top of the garden hose nozzle that has a barrel shaped front.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the rubber garden hose nozzle strap of the present invention mounted on a traditional garden hose nozzle in accordance with the disclosed architecture;

FIG. 2 illustrates a rear view of the garden hose and nozzle combination strap of the present invention mounted on a traditional garden hose nozzle in accordance with the disclosed architecture;

FIG. 3 illustrates a front view of the garden hose and nozzle combination strap of the present invention mounted on a traditional garden hose nozzle in accordance with the disclosed architecture;

FIG. 4 illustrates a top view of the garden hose and nozzle combination strap of the present invention in accordance with the disclosed architecture;

FIG. 5 illustrates a bottom view of the garden hose and nozzle combination strap of the present invention in accordance with the disclosed architecture;

FIG. 6 illustrates a perspective view of the process of mounting the garden hose and nozzle combination strap of the present invention on a nozzle in accordance with the disclosed architecture;

FIG. 7 illustrates a perspective view of the vertical hanging strap secured to the front barrel strap when the nozzle is not required to hang in accordance with the disclosed architecture;

FIG. 8 illustrates a side perspective view of one potential embodiment of the rubber garden hose nozzle strap of the present invention in accordance with the disclosed architecture;

FIG. 9 illustrates a rear perspective view of one potential embodiment of the rubber garden hose nozzle strap of the present invention in accordance with the disclosed architecture;

FIG. 10 illustrates a front perspective view of one potential embodiment of the rubber garden hose nozzle strap of the present invention in accordance with the disclosed architecture;

FIG. 11 illustrates a top perspective view of one potential embodiment of the rubber garden hose nozzle strap of the present invention in accordance with the disclosed architecture; and

FIG. 12 illustrates a bottom perspective view of one potential embodiment of the rubber garden hose nozzle strap of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a system that allows people to utilize the garden hose and nozzle combination as an outdoor hands-free shower or other watering application or use. There is also a long-felt need in the art for an invention that elevates a garden hose and/or nozzle in a vertical direction from the ground or connection level to a water supply. Additionally, there is a long-felt need in the art for a garden hose and nozzle combination supporting device that eliminates the need for people to continuously hold the hose or nozzle during use of the garden hose and/or nozzle. Moreover, there is a long-felt need in the art for a garden hose and nozzle combination supporting device that does not reduce or obstruct the water flow of the nozzle. Further, there is a long-felt need in the art for a garden hose nozzle supporting assembly that allows an individual to use the nozzle for easily rinsing hands, cleaning, bathing or other watering activity. Finally, there is a long-felt need in the art for a device that supports the hose nozzle in a hands-free and elevated position for rinsing off hands, tools, and other watering applications.

The present invention, in one exemplary embodiment, is a novel strap system for utilizing an existing garden hose and nozzle combination as an outdoor, stationary, and hands-free showering, cleaning and watering device is disclosed. The strap system is one-piece integral device that includes a vertical hanging strap with a closed loop, a front barrel strap, and a handle strap, and the front barrel strap wraps around front barrel head of the nozzle. The handle strap wraps around the grip or handle of the nozzle and the vertical hanging strap is provided with an opening 120 and is configured to slide onto a sturdy tree branch or garden hook to support the hose and nozzle in a hands-free elevated position. In addition, most hose nozzles comprise a triangular feature that when rotated up or down turns the water flow on or off.

Referring initially to the drawings,

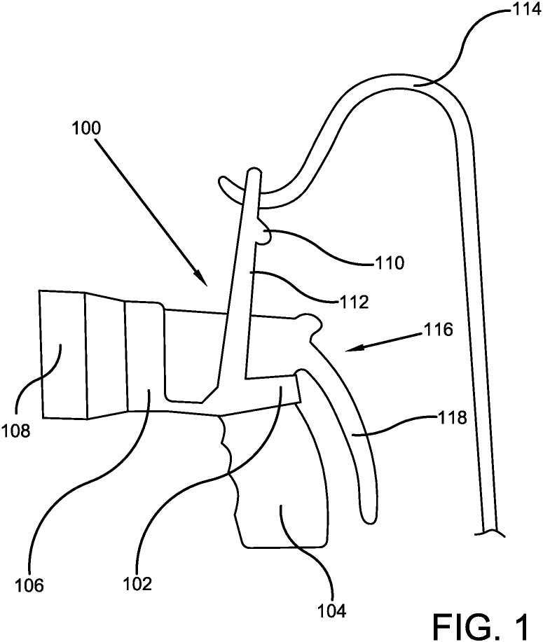

FIG. 1 illustrates a perspective view of one potential embodiment of the rubber garden hose nozzle strap 100 of the present invention mounted on a traditional garden hose nozzle in accordance with the disclosed architecture. The strap 100 is formed of a durable synthetic rubber, silicone or other elastic material and provides hands-free showering operation using the strap 100. In an alternative embodiment, the strap may be made from a semi- rigid plastic material such as polyethylene, polystyrene, recycled plastic materials or combinations. The strap 100 is especially useful in enabling the nozzle 116 to sprinkle or dispense water from an elevated position without requiring a user to extend an arm and hold the handle and trigger of the nozzle 116. In FIG. 1, the strap 100 is releasably attached to the nozzle 116. However, the strap 100 may also be permanently attached to the nozzle 116 and the nozzle may be sold with the strap mounted or otherwise affixed to the nozzle. More specifically, the strap 100 is an integral one-piece body having a handle strap 102 configured to releasably wrap around or encircle the grip 104 of the nozzle. The handle strap 102 is primarily a circular loop dimensioned as per diameter of the grip 104. When the nozzle strap 100 is deployed, the handle strap 102 slides up the grip 104 as shown in FIG. 3 to secure around the grip 104.

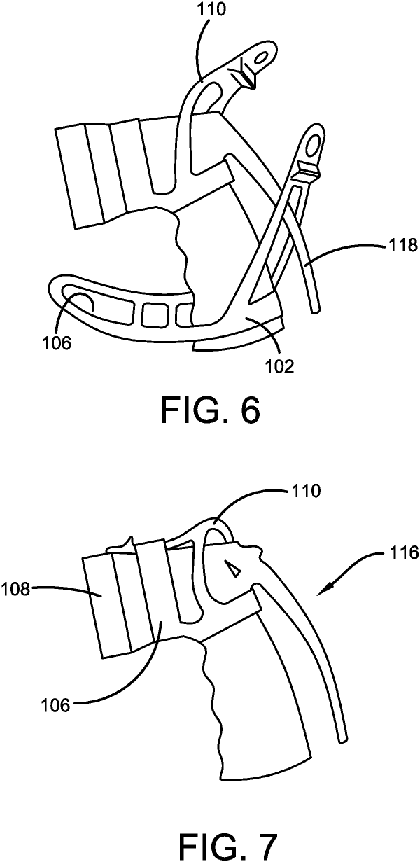

The strap 100 further has a front barrel strap 106 configured to releasably wrap around the front shower head 108 of the nozzle 116. During deployment of the strap 100, the front barrel strap 106 goes up over the front shower head 108 as shown in FIG. 6 to secure around the barrel head 108. The strap 100 also has a vertical hanging strap 110 having a closed loop 112 that is configured to slid onto a sturdy tree branch, post, wall, or garden hook 114 for supporting the nozzle and the associated hose in a hands-free elevated position.

The strap 100 does not obstruct functioning of the nozzle 116 and the trigger 118 can be easily triggered while the strap 100 is mounted on the nozzle 116. When rubber, silicone or other elastic materials are used, the material should have a stretch up to 150% of the original size of the strap 100.

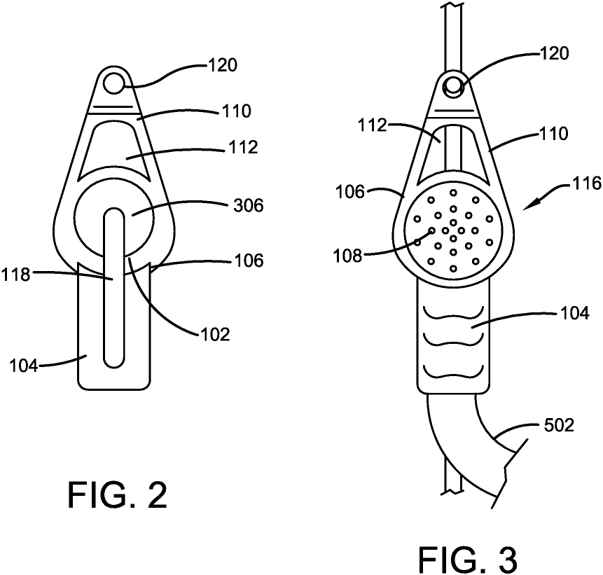

FIG. 2 illustrates a rear perspective view showing the position of the garden hose nozzle strap 100 on the exemplary nozzle 116 in accordance with the disclosed specification. As shown, in the rear perspective view, the vertical hanging strap 110 is positioned above the nozzle 116, thereby allowing a user to hang the strap 100 by sliding the vertical hanging strap 110 onto a hook, post, wall or tree branch using the hanging hole 120. The handle strap 102 is positioned between the trigger 118 and the grip 104 and therefore, does not obstruct operation of the trigger 118. Further, the handle strap 102 is also positioned between the front barrel strap 106 and the vertical hanging strap 110.

The handle strap 102, the front barrel strap 106 and the vertical hanging strap 110 are formed of stretchable or elastic material such as rubber or silicone or made to be manufactured from a semi-rigid plastic material such as polyethylene, polypropylene, recycled plastic material and combinations thereof. The strap is adjustable in length to accommodate different sizes, types and designs of the nozzles. The strap has a thickness ranging from about 0.25” to 1”, and a width of 0.5” to about 2.5”.

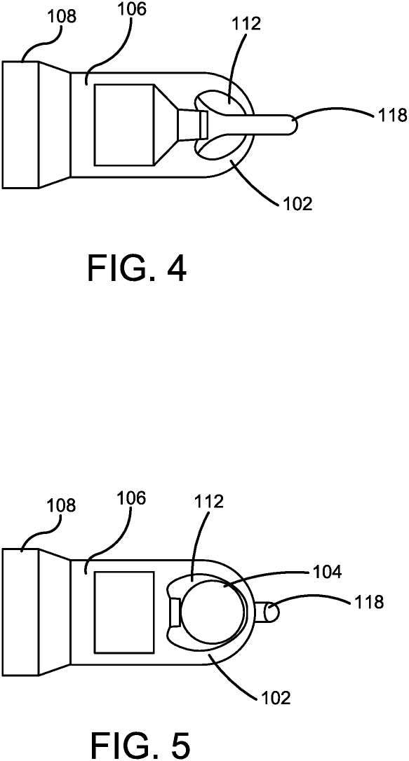

FIG. 3 illustrates a front view of the garden hose and nozzle combination strap 100 of the present invention mounted on a traditional garden hose nozzle 116. Similarly, FIG. 4 illustrates a top view of the garden hose and nozzle combination strap 100 of the present invention, and FIG. 5 illustrates a bottom view of the garden hose and nozzle combination strap 100. As shown in FIG. 4, the front barrel strap 106 wraps around a portion of the shower head 108 and the closed loop 112 of the vertical hanging strap encircles the trigger 118 and rear end 306 of the nozzle. The handle strap 102 encircles a portion of the grip as described earlier in the disclosure.

FIG. 6 illustrates a perspective view of the process of mounting the garden hose and nozzle combination strap 100 of the present invention on a nozzle 116 in accordance with the disclosed architecture. As stated earlier, the strap 100 is a single-piece integral structure made of flexible, elastic or semi-rigid material. For mounting the strap 100, initially, the handle strap 102 is positioned around the grip 104 of the nozzle 116. Then, the front barrel strap 106 up over the front shower head 108 of the nozzle 116. Thereafter or even simultaneously, the vertical hanging strap 110 is taken over the trigger 118 and rear end 306 of the nozzle. The handle strap 102, the front barrel strap 106 and the vertical hanging strap 110 together form a tight grip on the nozzle such that the nozzle can be hung at an elevated height by sliding the vertical hanging strap 110 onto a sturdy tree branch, post, wall, or garden hook to support the hose and the nozzle in a hands-free elevated position. In addition, a water flow control valve 311 may be provided to stop the flow. The strap may have indicia or graphics applied 315 and may be produced in any number of colors. The hanging strap may also be provided with an auxiliary fastener 317 to assist the individual in hanging the nozzle from different surfaces. FIG. 7 illustrates a perspective view of the vertical hanging strap 110 secured to the front barrel strap 106 when the nozzle 116 is not required to hang in accordance with the disclosed architecture.

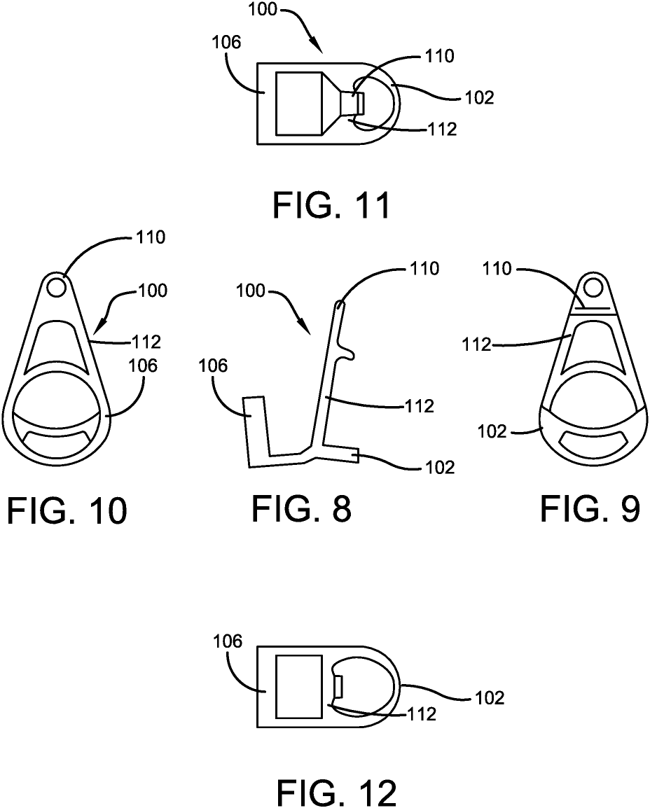

FIG. 8 illustrates a side perspective view of one potential embodiment of the rubber garden hose nozzle strap 100 of the present invention, and FIG. 9 illustrates a rear perspective view of one potential embodiment of the rubber garden hose nozzle strap 100 of the present invention in accordance with the disclosed architecture. The strap system 100 when mounted on a nozzle forms a tight grip with the handle strap 102 looping around the nozzle grip, the front barrel strap 106 looping around the front barrel and the vertical strap 110 extending above the nozzle. FIG. 8 is not drawn to scale but, as shown, the vertical hanging strap 110 has the largest dimensions and can easily hold the nozzle in a hanging position. FIG. 10 illustrates a front perspective view of one potential embodiment of the rubber garden hose nozzle strap 100 of the present invention in accordance with the disclosed architecture.

FIG. 11 illustrates a top perspective view of one potential embodiment of the rubber garden hose nozzle strap 100 of the present invention, and FIG. 12 illustrates a bottom perspective view of one potential embodiment of the rubber garden hose nozzle strap 100 of the present invention in accordance with the disclosed architecture.

In use, the nozzle head 108 is not covered or obstructed by the strap 100 and especially by the front barrel strap 106, and therefore the nozzle 116 can effectively sprinkle, dispense and spray water carried by the hose 502. Further, the vertical hanging strap 110 is positioned above the nozzle 116, thereby allowing a user to hang the nozzle by sliding the vertical hanging strap 110 onto a hook, post, wall, or tree branch using the hanging hole 120. Additionally, the grip 104 is not totally covered by the handle strap 102, and therefore can be easily gripped and handled when required.

As stated earlier, the vertical hanging strap 110 is used for hanging the nozzle from a point such as garden hook, post or other surface. When the nozzle 116 is not in use and is not required to hang, then, the vertical hanging strap 110 is secured between the front shower head 108 and the front barrel strap 106. This allows secure, easy and safe storage of nozzle and prevents the strap system 100 from physical damage.

When the nozzle 116 is required to be hung, the vertical hanging strap 110 can be taken out and used for sliding onto a hook, post, wall, or tree branch. In yet another embodiment, an on/off sprayer tab 313 may be located on top of the garden hose nozzle that has a barrel shaped front. The rubber hanging strap for supporting a spray nozzle may further comprise a tab that is secured under the barrel portion when the spray nozzle is not in use. The tab is preferably located on the back side of the vertical portion of the strap.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rubber strap”, “strap”, “rubber strap system”, “nozzle hanging strap”, “rubber garden hose nozzle strap”, and “garden hose nozzle hanging strap” are interchangeable and refer to the rubber garden hose nozzle strap 100 of the present invention, which has never been tested. Also, the nozzle strap 100 must be kept clear of any of the functionality of the hose nozzle.

Notwithstanding the forgoing, the rubber garden hose nozzle strap 100 of the present invention can be of any suitable size and configuration as is known in the art without affecting the overall concept of the invention, provided that it accomplishes the above stated objectives. One of ordinary skill in the art will appreciate that the rubber garden hose nozzle strap 100 as shown in the FIGS. are for illustrative purposes only, and that many other sizes and shapes of the rubber garden hose nozzle strap 100 are well within the scope of the present disclosure. Although the dimensions of the rubber garden hose nozzle strap 100 are important design parameters for user convenience, the rubber garden hose nozzle strap 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A strap device for a watering nozzle, the strap device comprising:
a handle strap;
a front barrel strap; and
a hanging strap having an opening for supporting the strap device from a surface, wherein the front barrel strap and the handle strap are connected to one another, and further wherein the hanging strap is connected to the handle strap.

2. The strap device for a watering nozzle as recited in claim 1, wherein the strap device is comprised of a select one of a flexible material and an elastic material.

3. The strap device for a watering nozzle as recited in claim 2, wherein the elastic material is one of a rubber or a silicone.

4. The strap device for a watering nozzle as recited in claim 2, wherein the semi-rigid material is one of a polyethylene, a polystyrene, a recycled plastic or a combination thereof.

5. The strap device for a watering nozzle as recited in claim 1, wherein the strap device has a thickness ranging from about 0.25” to 1”, and a width ranging from about 0.5” to about 2.5”.

6. The strap device for a watering nozzle as recited in claim 2, wherein the elastic material has a stretchability factor of up to 150%.

7. The strap device for a watering nozzle as recited in claim 1, wherein the handle strap comprises an extension strap.

8. The strap device for a watering nozzle as recited in claim 7, wherein the watering nozzle comprises a triangular feature for holding a trigger of a nozzle in a desired position.

9. The strap device for a watering nozzle as recited in claim 1 further comprising a tab.

10. The strap device for a watering nozzle as recited in claim 1, wherein the strap device is comprised of a semi-rigid material.

11. A combination holding strap and water nozzle comprising:
a water nozzle having a barrel, a handle and a trigger; and
a strap having a handle portion for fitting over the handle of the water nozzle, a barrel strap for fitting over the barrel of the water nozzle and a hanging strap for supporting the water nozzle at a desired height, wherein the strap is comprised of a select one of an elastic material, a flexible material or a semi-rigid material, and further wherein the strap has a thickness ranging from about 0.25” to 1” and a width ranging from about 0.5” to 2.5”.

12. The combination holding strap and water nozzle as recited in claim 11, wherein the water nozzle comprises a triangular feature for holding the trigger of the water nozzle in a preferred position.

13. The combination holding strap and water nozzle as recited in claim 11, wherein the strap further comprises an indicia or a graphic.

14. The combination holding strap and water nozzle as recited in claim 11, wherein the hanging strap comprises a loop for hanging the combination holding strap and water nozzle from a surface.

15. The combination holding strap and water nozzle as recited in claim 14 further comprising an auxiliary fastener connected to the loop on the hanging strap.

16. The combination holding strap and water nozzle as recited in claim 11, wherein the elastic material is comprised of a rubber or a silicone.

17. A rubber hanging strap for supporting a spray nozzle, the rubber hanging strap comprising:
a strap having a barrel portion, a handle portion and a hanging portion sized and configured to fit on the spray nozzle;
the handle portion positioned on a handle of the spray nozzle, the barrel portion disposed on a barrel of the spray nozzle and the hanging portion used to support the spray nozzle from a hook; and
the strap having a thickness ranging from about 0.25” to 1”, a width of 0.5” to about 2.5” and a stretchability factor of up to 150%.

18. The rubber hanging strap for supporting a spray nozzle as recited in claim 17 further comprising a tab that is secured under the barrel portion when the spray nozzle is not in use.
